(19) United States
(12) Patent Application Publication
(10) Pub. No.: US 2026/0200066 A1
(43) Pub. Date: Jul. 16, 2026

(54) APPARATUS AND METHODS FOR SHEAR VALVES IN HYDRAULIC POWER TOOLS

(71) Applicant: Milwaukee Electric Tool Corporation, Brookfield, WI (US)

(72) Inventors: Brandon Meister, Brookfield, WI (US); Mathew R. Rentmeester, Wauwatosa, WI (US); Justin Martin, Brookfield, WI (US); Harrison T. Snyder, Pewaukee, WI (US)

(21) Appl. No.: 19/449,169

(22) Filed: Jan. 14, 2026

Related U.S. Application Data
(60) Provisional application No. 63/745,666, filed on Jan. 15, 2025.

(51) Int. Cl. B25F 5/00; F15B 13/04

(52) U.S. Cl. CPC B25F 5/005; F15B 13/0406

(57) ABSTRACT

A hydraulic tool includes a valve body having a sealing surface, a side surface, and a first fluid channel to fluidly couple the sealing surface and the side surface. The valve body rotates between a first position and a second position. A shear seal contacts the sealing surface, the shear seal including a second fluid channel to selectively fluidly couple to the first fluid channel when the valve body is in the first position and selectively fluidly seal against the sealing surface when the valve body is in the second position. An input shaft is coupled to the valve body via a one-way bearing. The one-way bearing rotationally couples the input shaft to the valve body when the input shaft rotates in a first direction and rotationally decouples the input shaft from the valve body when the input shaft rotates in a second direction that is opposite.

### CROSS-REFERENCE TO RELATED APPLICATIONS

The present application is based on and claims priority to United States Provisional Patent Application 63/745,666, filed January 15, 2025, which is incorporated herein by reference in its entirety.

### FIELD

The present disclosure relates generally to power tools. More particularly, the present disclosure relates to apparatus and methods for shear valves in hydraulic power tools.

### BACKGROUND

Some hydraulic power tools, for example crimpers and cutters, include a hydraulic piston and a cylinder that can exert force on a tool head or other working surface of the tool. Some hydraulic power tools use electric motors to drive hydraulic pumps that supply pressurized hydraulic fluid to the piston. In this way an electric or battery-operated power tool can be used to generate hydraulic pressure. A valve, for example, a shear valve or dump valve, can be used to relieve hydraulic pressure acting on the piston of the power tool.

### SUMMARY

Examples of the invention provide systems, tools, hydraulic valves, and methods associated with a dual-purpose shear valve.

In some aspects, a hydraulic tool can include a valve body including a sealing surface and a side surface. The valve body can rotate between a first position and a second position. A first fluid channel can fluidly couple the sealing surface and the side surface. A shear seal can contact the sealing surface. The shear seal can include a second fluid channel to selectively fluidly couple to the first fluid channel when the valve body is in the first position and selectively fluidly seal against the sealing surface when the valve body is in the second position. The hydraulic tool can include an input shaft. A one-way bearing can be coupled between to the valve body and the input shaft to control rotation of the valve body so that the one-way bearing rotationally couples the input shaft to the valve body when the input shaft rotates in a first direction and rotationally decouples the input shaft from the valve body when the input shaft rotates in a second direction that is opposite.

In some examples, the hydraulic tool may further include a manual input coupled to the valve body so that actuation of the manual input rotates the valve body from the second position to the first position. In some examples, the hydraulic tool may further include a biasing element configured to bias the valve body toward the second position. In some examples, the first direction may correspond to the valve body rotating from the second position to the first position. In some examples, the valve body may include a protrusion configured to contact a surface of the hydraulic tool when the valve body is in the first position. The surface may be configured to prevent rotation of the valve body in the first direction when the protrusion contacts the surface. In some examples, the input shaft may be a pump shaft of the hydraulic tool. In some examples, the hydraulic tool may further include a motor coupled to the input shaft. In some examples, the hydraulic tool may be configured to generate hydraulic pressure when the motor rotates the input shaft in the second direction. In some examples, the one-way bearing may be configured to hold the valve body in the first position when the input shaft is stationary. In some examples, the hydraulic tool may further include a thrust bearing disposed between the valve body and a pump housing. In some examples, the sealing surface may be substantially perpendicular to an axis of rotation of the valve body.

In some aspects, a shear seal valve can include a one-way clutch including a drive member and a driven member. A valve body can define a first fluid passage. The valve body can be coupled to rotate with the driven member so that the valve body rotates with the drive member when the drive member is rotated in a first direction and is rotatable relative to the drive member when the drive member is rotated in a second direction that is opposite the first direction. A manual input can be coupled to the valve body so that actuation of the manual input causes the valve body to rotate relative to the drive member.

In some examples, the shear seal valve may further include a shear seal that couples to the first fluid passage when the valve body is in a first position and that seals against the valve body when the valve body is in a second position. In some examples, the shear seal may be biased toward the valve body by a resilient member. In some examples, rotation of the drive member in the first direction or actuation of the manual input may cause the valve body to move from the second position to the first position. In some examples, the one-way clutch may be configured to hold the valve body in a position when the drive member is stationary and the manual input is released. In some examples, the shear seal valve may further include a spring to bias the manual input toward an unactuated position and to bias the valve body toward a sealed position. In some examples, the drive member may be coupled to a cam of a hydraulic pump.

In some aspects, a method of operating a hydraulic tool can include rotating an input shaft in a first direction to generate pressure in a hydraulic fluid. The method can include rotating the input shaft in a second direction that is opposite the first direction. The method can include rotating a valve body from a closed position to an open position based on rotation of the input shaft in the second direction. The method can include releasing the hydraulic fluid through a fluid channel of the valve body when the valve body is in the open position. The input shaft can be coupled to the valve body via a one-way clutch. The one-way clutch can be configured to rotationally couple the input shaft to the valve body when the input shaft rotates in the second direction and rotationally decouple the input shaft from the valve body when the input shaft rotates in the first direction.

In some examples, the method may further include manually actuating a manual input coupled to the valve body to rotate the valve body from the closed position to the open position while the input shaft is stationary.

### BRIEF DESCRIPTION OF THE DRAWINGS

The novel features believed characteristic of the illustrative examples are set forth in the appended claims. The illustrative examples, however, as well as a preferred mode of use, further objectives, and descriptions thereof, will best be understood by reference to the following detailed description of one or more illustrative examples of the present disclosure when read in conjunction with the accompanying drawings, wherein:

FIG. 1 is a perspective view of a hydraulic tool including a drive motor and a shear valve, according to an example.

FIG. 2 is a diagrammatic view of the power tool of FIG. 1.

FIG. 3 is a perspective view of an example of the shear valve of FIG. 1 coupled to a pump cam shaft of the hydraulic tool.

FIG. 4A is a left view of the shear valve of FIG. 3.

FIG. 4B is a front view of the shear valve of FIG. 3.

FIG. 4C is a right view of the shear valve of FIG. 3.

FIG. 5 is a perspective view of the shear valve of FIG. 3 with portions of the shear valve shown transparent to illustrate fluid channels and a one-way bearing.

FIG. 6A illustrates the shear valve of FIG. 3 in an open position.

FIG. 6B illustrates the shear valve of FIG. 3 in a closed position.

FIG. 7 is a flowchart representative of a method of activating a shear valve in a hydraulic tool.

### DETAILED DESCRIPTION

Power tools (e.g., hydraulic power tools) can be used to perform cuts or crimps on a work piece, for example a cable. Generally, hydraulic tools include a cylinder and a piston configuration, where a piston is configured to extend and retract within a cylinder, and thus, move jaws, or any other implement coupled to the piston to perform a task (crimping, cutting, etc.). In some conventional hydraulic power tools, a hydraulic circuit can include a shear valve. The shear valve can be used to release or otherwise direct hydraulic fluid from the piston to a fluid reservoir. Additionally, some conventional hydraulic power tools include a manually actuated dump valve to release or otherwise reduce hydraulic pressure in the power tool, particularly in the event of a power failure or other malfunction.

The present disclosure provides a hydraulic shear valve that combines the functions of a manual dump valve and a hydraulic release valve for use in a hydraulic power tool. In this way, a manual actuator (e.g., button, toggle, lever, etc.) can connect to the shear valve to provide a second method of actuating the relief valve. In some examples, the shear valve is coupled to a drive shaft (e.g., a cam shaft) of a hydraulic pump via a one-way clutch (e.g., a sprag bearing, a roller ramp clutch, ratchet-and-pawl, a one-way bearing, etc.). In this way, the drive shaft is a drive member of the one-way clutch and a valve body of the shear valve is a driven member of the one-way clutch. The one-way clutch is configured to selectively lock the drive shaft against rotation in a first direction and to freely allow the drive shaft to rotate in a second direction that is opposite the first direction. In this way, the one-way clutch allows the drive shaft to rotate freely when the hydraulic pump is generating pressure to actuate a hydraulic piston. Conversely, when the hydraulic pump is no longer needed, for example at the end of a loading cycle, the drive shaft can turn in an opposite direction causing the one-way clutch to rotate (e.g., actuate) the shear valve.

The one-way clutch is configured to hold the valve body in a position when the drive member is stationary and the manual input is released.

The systems and methods disclosed herein for shear valves in hydraulic power tools allow for new methods of controlling hydraulic power tools. A single rotational actuator (e.g., an electric motor, an alternating current motor, a direct current motor, a pneumatic motor, etc.) can be used to both drive the hydraulic pump and release the pressurized hydraulic fluid back into the reservoir. A non-limiting example method includes a user initiating a working cycle of the hydraulic power tool, and a controller activating an electric motor to rotate a shaft of a hydraulic pump in a second direction. The hydraulic pump raises a working pressure of the hydraulic power tool until a threshold pressure is reached. Subsequently, the controller activates the electric motor to rotate the shaft in a first direction. Because a shear seal is mounted on a one-way clutch, the shear seal rotates in the first direction, thereby activating a shear valve to lower the working pressure of the hydraulic power tool. Thus, the motor (e.g., the electric motor) can be used to both increase the working pressure and decrease the working pressure by operating a shear seal valve. Correspondingly a shear seal valve can be used to both fill and empty a cylinder of a hydraulic actuator.

Apparatus and methods disclosed herein advantageously enable hydraulic power tool designers to simplify tool design. Example shear valves disclosed herein combine dump valves and shear valves into a single component, reducing weight, part count, and freeing space within the tool. Further, example shear valves disclosed herein utilize one-way clutches to enable an electric motor (e.g., a motor for a hydraulic pump) to additionally actuate the shear valve. Thus, example shear valves disclosed herein eliminate a separate release valve that is operated to release fluid from the hydraulic cylinder, as with conventional arrangements. The methods and apparatus disclosed herein advantageously simplify hydraulic shear valves to reduce cost, weight, and size of any hydraulic power tool, thereby providing distinct benefits for laborers who purchase and use handheld power tools.

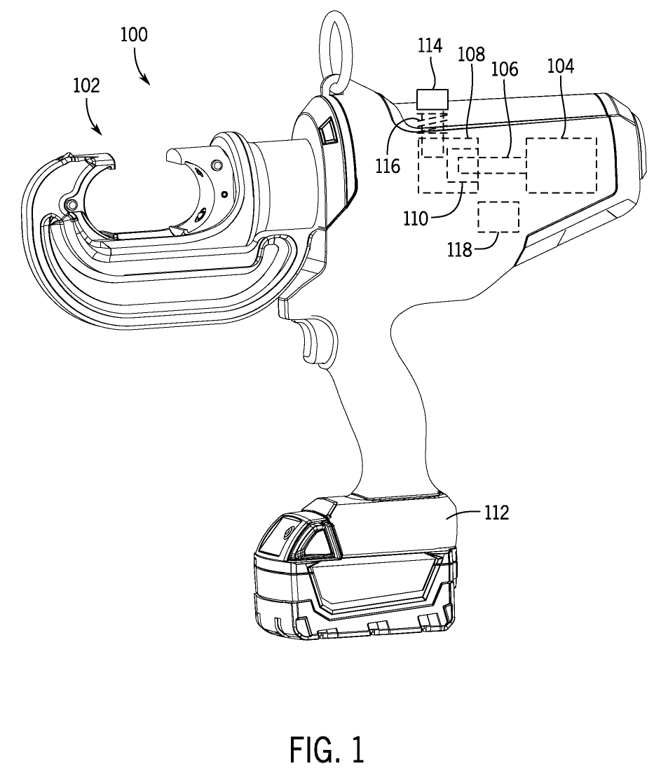

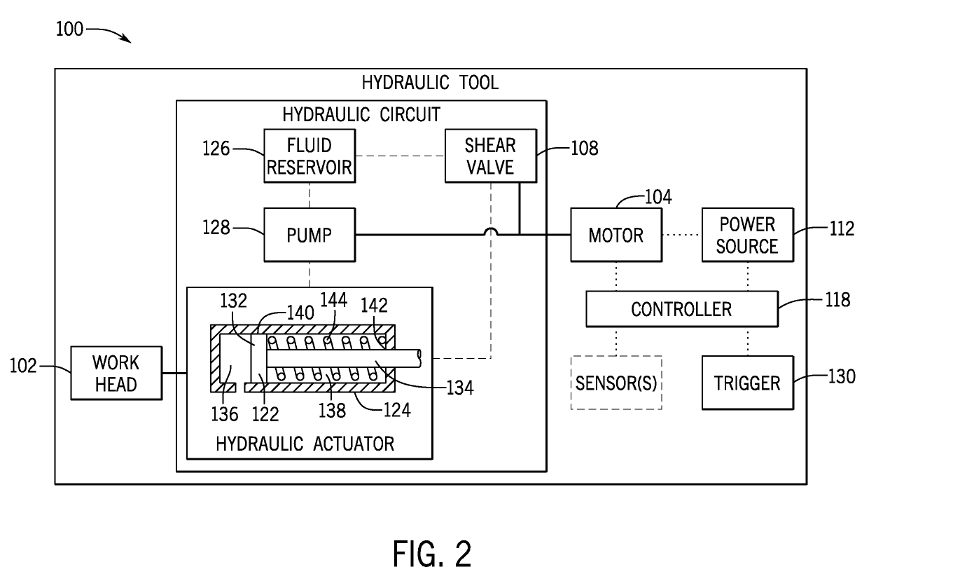

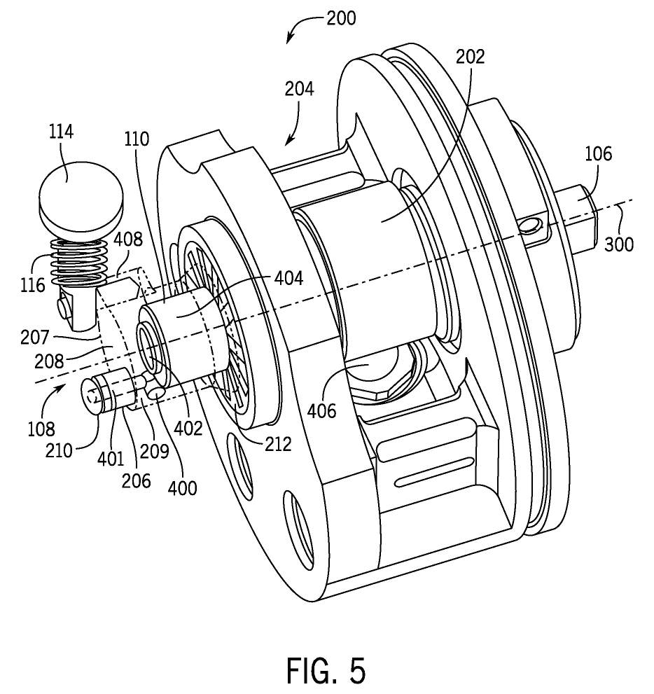

FIG. 1 illustrates a hydraulic tool 100, for example, configured as a crimper having a crimping or work head 102. In other examples, the hydraulic tool 100 can include additional or alternative crimping or cutting features near the work head 102. For example, the hydraulic tool 100 can be configured as a cutter, or another type of hydraulic tool (e.g., a knockout tool, jack, pump, etc.). The hydraulic tool 100 includes a drive motor 104 (e.g., a motor) that is coupled to a pump cam shaft 106 (e.g., a pump shaft, an input shaft) to drive (e.g., rotate) the pump cam shaft 106. The pump cam shaft 106 is used to actuate a pump cam in a pump to generate hydraulic pressure within a hydraulic actuator, as further detailed below in reference to FIGS. 2 and 5. A shear valve 108 (e.g., a shear seal valve, a rotary valve) is coupled to the pump cam shaft 106 via a one-way clutch 110 (e.g., a one-way bearing). The one-way clutch 110 is configured to selectively rotationally couple the shear valve 108 to the pump cam shaft 106 based on a direction of rotation of the pump cam shaft 106. In other words, the pump cam shaft 106 rotationally couples to the shear valve 108 when rotating in a first direction (e.g., a first rotational direction, a valve actuating direction, a locking direction), and the pump cam shaft 106 freely rotates within the shear valve 108 when the pump cam shaft 106 is rotating in a second direction (e.g., a second rotational direction, a pressure generating direction, a free rotation direction). The second direction is opposite the first direction. In this way, the drive motor 104 actuates (e.g., rotates, drives, etc.) the shear valve 108 while rotating in the first direction and generates hydraulic pressure while rotating in the second direction. The hydraulic tool 100 is configured to generate hydraulic pressure when the motor 104 rotates the pump cam shaft 106 in the second direction. In the example of FIG. 1, the drive motor 104 is an electric motor powered by a rechargeable battery 112 (e.g., a power source). In other examples, the drive motor 104 can be a different kind of rotary actuator powered by any power source, for example as a pneumatic motor powered by compressed air, or the drive motor 104 can receive electric power from an external source. The drive motor 104 can include gearing, a transmission, or any other mechanism to provide sufficient torque and/or speed for the operation of the hydraulic tool 100.

The hydraulic tool 100 includes a manual dump actuator 114 (e.g., a manual input) coupled to the shear valve 108. The manual dump actuator 114 is configured to receive a user input (e.g., to be pressed) and transfer the user input to the shear valve 108. In this way, the shear valve 108 is rotated or otherwise actuated by a user input via the manual dump actuator 114. In other words, actuation of the manual dump actuator 114 causes the valve body 207 to rotate relative to the pump cam shaft 106. The manual dump actuator 114 is biased towards an extended position (e.g., an unpressed position, an unactuated position) by a spring 116 (e.g., a biasing element). The spring 116 exerts sufficient force on the manual dump actuator 114 to restore the manual dump actuator 114 to the extended position when the shear valve 108 is decoupled from the pump cam shaft 106. Likewise, the spring 116 exerts sufficient force on the shear valve 108 to restore the shear valve 108 from an open position (e.g., an unsealed position, an actuated position, a first position) to a closed position (e.g., a sealed position, an unactuated position, a second position). In this way, the spring 116 biases the manual dump actuator 114 toward the unactuated position and biases the valve body 207 toward the closed position. Similarly, actuation of the manual dump actuator 114 rotates the valve body 207 from the closed position to the open position.

In some non-limiting examples, the hydraulic tool 100 includes a controller 118. The controller 118 sends control commands to the drive motor 104. The controller 118 can monitor states of the hydraulic tool 100 and user inputs (e.g., trigger activation, etc.) and perform operational processes based on the states and user inputs. For example, the controller 118 can monitor for a user input corresponding to a valve open command and, in response to receiving the user input corresponding to the valve open command, direct the drive motor 104 to rotate in the first direction to open the shear valve 108.

FIG. 2 shows the hydraulic tool 100 diagrammatically to illustrate an example hydraulic circuit that can be used to selectively engage and disengage the work head 102. A hydraulic actuator 120 is disposed in the hydraulic tool 100 and is operable to perform a work operation of the hydraulic tool 100 (e.g., a crimp, a cut, a punch, etc.). In particular, the hydraulic actuator 120 actuates the work head 102 between an open configuration and a closed configuration. The hydraulic actuator 120 can include a piston 122 that is movably received in a cylinder 124. The cylinder 124 can be fixed to a housing of the hydraulic tool 100 and the piston 122 can move relative to the cylinder 124 in response to hydraulic fluid being supplied to or removed from the cylinder 124. For example, fluid can be supplied from a reservoir 126 to the cylinder 124 via a pump 128 to move the piston 122 in a first direction, and drained from the cylinder 124 to the reservoir 126 to move the piston 122 in a second direction that is opposite the first direction.

To operate the hydraulic tool 100, the hydraulic tool 100 can include a trigger 130. The trigger 130 can be manipulated by a user to actuate the hydraulic tool 100 and perform the work operation. The motor 104 can be coupled to the pump 128 so that rotation of the motor 104 operates the pump 128 to supply pressurized hydraulic fluid to the hydraulic actuator 120. For example, the motor 104 can be coupled to the pump cam shaft 106, which is coupled to the pump.

In some cases, the motor 104 can be coupled to the pump 128 via a transmission (e.g., a gear reducer) so that rotation of the motor 104 operates the pump 128 to supply pressurized hydraulic fluid to the hydraulic actuator 120 and actuates the work head 102.

The pump 128 supplies hydraulic fluid from the reservoir 126 (e.g., a tank) to the hydraulic cylinder 124. In general, the hydraulic cylinder 124 includes the piston 122 having piston head 132 and a piston rod 134, which transmit force to the work head 102. The piston 122 is movably received in the cylinder 124 to form a first chamber 136 and a second chamber 138 within an internal volume of the cylinder 124. In this example, the piston head 132 responds to hydraulic pressure differentials between the first chamber 136 and the second chamber 138, which generate forces that move the piston rod 134 and the connected work head 102. A piston seal 140 provides a seal between the piston head 132 and the cylinder 124 to prevent fluid from leaking between the first chamber 136 and the second chamber 138. A rod seal 142 is provided to seal between the cylinder 124 and the piston rod 134 to prevent hydraulic fluid from leaking out of the cylinder 124.

To operate the hydraulic actuator 120, the hydraulic cylinder 124 uses pressurized fluid to create mechanical motion. For example, hydraulic fluid is pumped into the first chamber 136 from the reservoir 126. The pressure acting on a surface area of the piston 122 generates a force that causes the piston 122 to move within the cylinder 124 between a first position (e.g., a retracted position or an extended position) and a second position (e.g., the other of the retracted position and the extended position). This linear motion of the piston 122 is transmitted through the piston rod 134 to operate the work head 102 and transition the work head 102 between an opened position and a closed position. In some cases, the hydraulic cylinder 124 is single acting. For example, hydraulic fluid is pumped to apply pressure to one side (e.g., first chamber 136) of the piston 122. Therefore, the piston 122 can only move in one direction by the generation of the force. A return mechanism 144 (e.g., biasing member, spring, or gravity) is used to return the piston 122 from the second position to the first position. In other cases, the hydraulic cylinder 124 is double-acting. For example, hydraulic fluid is pumped to apply pressure to both sides (e.g., the first chamber 136 and a second chamber 138) of the piston 122. In particular, hydraulic fluid creates pressure along a surface in the first chamber 136, generating a force to move the piston 122 between the first position and the second position. To move the piston 122 between the second position and the first position, hydraulic fluid creates pressure along a surface in the second chamber 138 to generate a force to return the piston 122 to the first position.

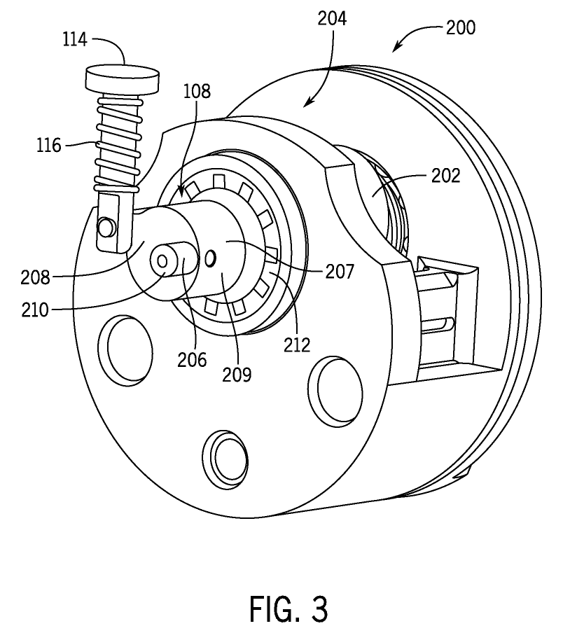

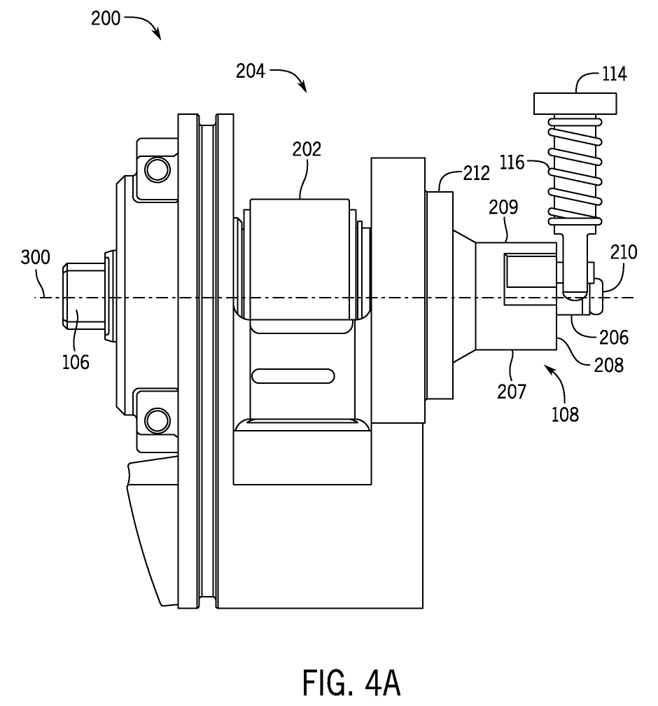

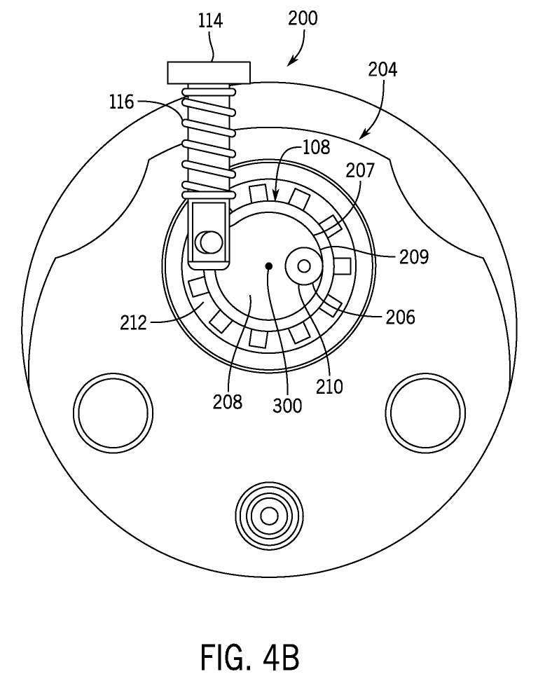

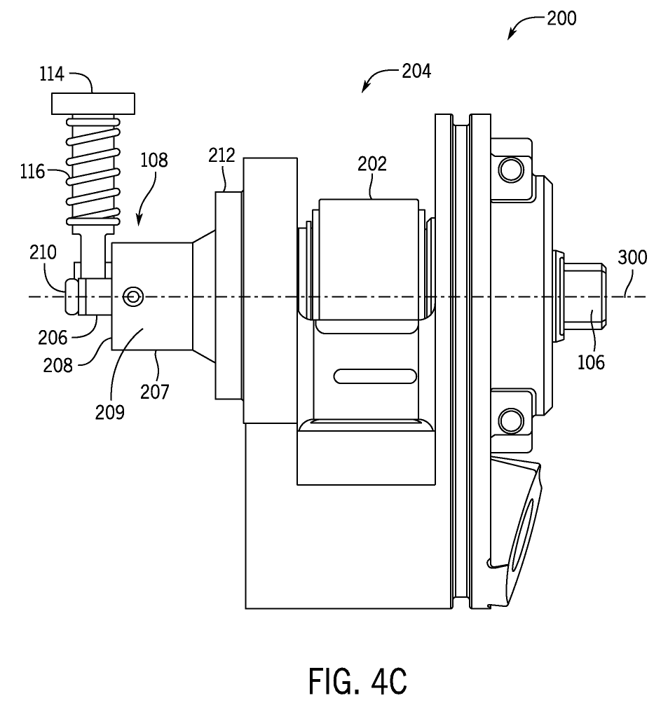

FIGS. 3-4C illustrate an example of the shear valve 108 of FIG. 1 coupled to a pump housing 200 of the pump 128 of the hydraulic tool 100. The pump housing 200 can be disposed in the hydraulic fluid reservoir 126 or another chamber fluidly coupled to the hydraulic fluid reservoir. For clarity, components of the hydraulic tool 100 have been removed. However, it should be understood that additional components can be coupled to the pump housing 200 and/or the shear valve 108 as required for a functional hydraulic circuit. The pump housing 200 is rotatably coupled to the pump cam shaft 106 so that the pump cam shaft 106 is supported by the pump housing 200 and can freely rotate. A cam 202 is disposed in a pump chamber 204 of the pump housing 200 and is coupled to the pump cam shaft 106 so that the cam 202 and the pump cam shaft 106 share an axis of rotation 300. The cam 202 is eccentric relative to the axis of rotation 300. The cam 202 actuates a piston of the pump 128, as detailed below in reference to FIG. 5, based on a rotational position of the cam 202. In other words, the hydraulic tool 100 generates hydraulic pressure to actuate the work head 102 by rotating the pump cam shaft 106 via the drive motor 104 to actuate the piston of the pump 128 via the cam 202. The drive member 402 of the one-way clutch 110 is coupled to the cam 202 of the hydraulic pump (e.g., the pump 128).

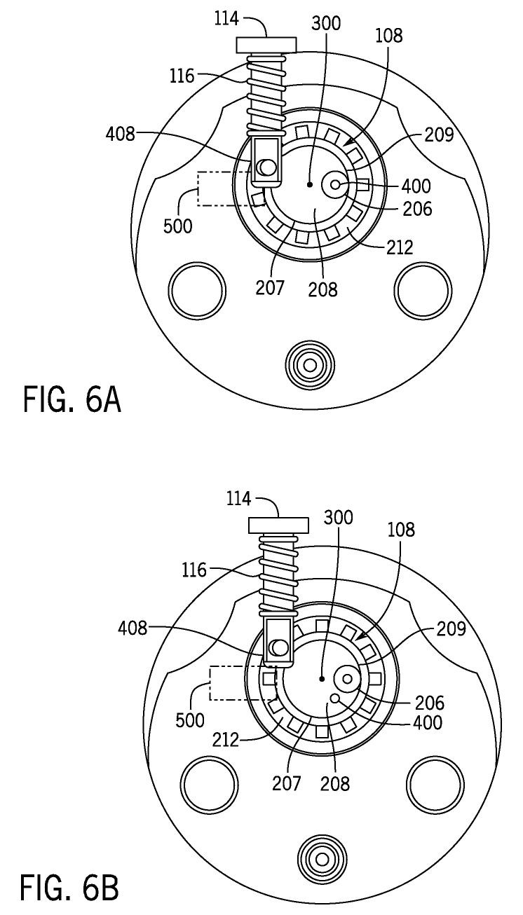

The shear valve 108 includes a shear seal disc 206 (e.g., a shear seal) and a valve body 207. The valve body 207 is coupled to an end of the pump cam shaft 106, opposite the drive motor 104 (see FIG. 1). The valve body 207 includes a sealing surface 208 that is configured to seal against the shear seal disc 206. In other words, the shear seal disc 206 contacts the sealing surface 208. The shear seal disc 206 is biased toward the sealing surface 208 of the valve body 207 by a seal 210 (e.g., or another type of resilient member). The shear seal disc 206 and the seal 210 are disposed in a hydraulic housing (e.g., the fluid reservoir 126) coupled to the pump housing 200 so that the seal 210 is compressed between the shear seal disc 206 and the hydraulic housing. In this way, sufficient pressure is generated between the sealing surface 208 and the shear seal disc 206 to substantially prevent hydraulic fluid from escaping between the sealing surface 208 and the shear seal disc 206 when the valve body 207 is in the closed position, as further detailed below in reference to FIG. 6B. In some examples, a thrust bearing 212 is disposed between the valve body 207 and the pump housing 200 to reduce friction between the valve body 207 and the pump housing 200 when the valve body 207 rotates. The valve body 207 also includes a side surface 209 that extends around a periphery of the valve body 207.

FIG. 5 is a perspective view of the shear valve 108 of FIG. 3 with portions of the shear valve 108 shown transparent to illustrate the one-way clutch 110, a first fluid channel 400, and a second fluid channel 401. The first fluid channel 400 (e.g., a first fluid passage) starts at the sealing surface 208 and extends through the valve body 207 to fluidly couple the sealing surface 208 with the side surface 209 of the valve body 207. The second fluid channel 401 (e.g., a second fluid passage) extends through the shear seal disc 206. The valve body 207 of FIG. 5 is illustrated in the open position in FIG. 6A. The open position corresponds with the first fluid channel 400 being fluidly coupled with the second fluid channel 401 of the shear seal disc 206. In other words, the shear seal disc 206 couples to (e.g., fluidly couples to) the first fluid channel 400 when the valve body 207 is in the open position. When the first fluid channel 400 is fluidly coupled with the second fluid channel 401, fluid from a hydraulic cylinder flows through the shear seal disc 206 and the valve body 207 to return to the hydraulic fluid reservoir 126. When the valve body 207 is in the closed position, as shown in FIG. 6B, the shear seal disc 206 contacts the sealing surface 208 of the valve body 207 to fluidly decouple the first fluid channel 400 from the second fluid channel 401. The shear seal disc 206 seals against the valve body 207 (e.g., the sealing surface 208) when the valve body 207 is in the second position. In this way, the valve body 207 rotates to the closed position to selectively fluidly seal the shear seal disc 206 against the sealing surface 208 to prevent hydraulic fluid from flowing through the shear seal disc 206 and into the hydraulic fluid reservoir 126. Thus, the valve body 207 rotates about the pump cam shaft 106 between the open position and the closed position to selectively fluidly couple and selectively fluidly decouple a hydraulic piston and the hydraulic fluid reservoir 126.

The one-way clutch 110, or clutch bearing (e.g., a one-way bearing), is coupled between the valve body 207 and the pump cam shaft 106 to control rotation of the valve body 207. The one-way clutch 110 rotationally couples the pump cam shaft 106 to the valve body 207 when the pump cam shaft 106 rotates relative to the valve body 207 in the first direction, but the one-way clutch 110 allows for free rotation of the pump cam shaft 106 relative to the valve body 207 in the second direction, which is opposite the first direction. In other words, the one-way clutch 110 selectively rotationally couples and rotationally decouples the pump cam shaft 106 to the valve body 207 based on a direction of rotation of the pump cam shaft 106 relative to the valve body 207. The one-way clutch 110 includes a drive member 402 coupled to the pump cam shaft 106 (e.g., an input shaft) and a driven member 404 coupled to the valve body 207. The valve body 207 is coupled to rotate with the driven member 404 so that the valve body 207 rotates with the drive member 402 when the drive member 402 is rotated in the first direction and is rotatable relative to the drive member 402 when the drive member 402 is rotated in the second direction that is opposite the first direction. Relative rotation between the drive member 402 and the driven member 404 in the first direction causes the one-way clutch 110 to engage to couple the drive member 402 to the driven member 404. The pump cam shaft 106, the one-way clutch 110, and the valve body 207 share the axis of rotation 300 that is substantially perpendicular to the sealing surface 208. In this way, the sealing surface 208 maintains contact with the shear seal disc 206 as the valve body 207 rotates. The first direction corresponds to the valve body 207 rotating from the closed position to the open position. Rotation of the drive member 402 in the first direction or actuation of the manual dump actuator 114 causes the valve body 207 to move from the second position to the first position. The one-way clutch 110 is configured to hold the valve body 207 in the first position when the pump cam shaft 106 is stationary.

In operation, the pump cam shaft 106 rotates in the second direction to actuate a pump piston 406. The pump piston 406 reciprocates based on a rotational position of the cam 202 to generate hydraulic pressure for use in the hydraulic actuator 120 (e.g., the hydraulic cylinder 124 and the hydraulic piston 122) to actuate the work head 102 of the hydraulic tool 100. For example, the cam 202 is coupled to the pump cam shaft 106 and configured to oscillate the pump piston 406 so that the pump piston 406 generates hydraulic pressure when the pump cam shaft 106 is rotating in the second direction. When the pump cam shaft 106 rotates in the first direction, the valve body 207 becomes coupled to the pump cam shaft 106 and rotates from the closed position to the open position. In some non-limiting examples, a protrusion 408 (shown in FIG. 5) extending from a sidewall of the valve body 207 is configured to contact a surface 500 (shown in FIGS. 6A and 6B) of the hydraulic tool 100 when the valve body 207 is in the open position. The surface 500 is configured to prevent rotation of the valve body 207 in the first direction when the protrusion 408 contacts the surface 500. In this way, the protrusion 408 stops the rotation of the valve body 207 at the open position to align the first fluid channel 400 with the second fluid channel 401. For clarity, the surface 500 is shown transparent and uncoupled, but it is understood that the surface 500 is coupled to an interior structure of the hydraulic tool 100 and positioned to make contact with the protrusion 408.

Additionally, the manual dump actuator 114 is rotationally coupled to the valve body 207 at a position spaced apart (e.g., radially offset) from a rotational axis of the valve body 207 (e.g., the axis of rotation 300) so that translation of the manual dump actuator 114 causes rotation of the valve body 207. The manual dump actuator 114 is configured to move in a substantially linear direction relative to the hydraulic tool 100 when pressed or otherwise actuated by a user. When the manual dump actuator 114 is pressed, the valve body 207 is rotated relative to the pump cam shaft 106 in the first direction so that the one-way clutch 110 allows rotational decoupling of the valve body 207 from the pump cam shaft 106. In other words, rotating the valve body 207 in the first direction when the pump cam shaft 106 is stationary induces the same relative rotation between the drive member 402 and the driven member 404 of the one-way clutch 110 (e.g., for free rotation) as rotating the pump cam shaft 106 in the second direction when the valve body 207 is stationary. In this way, a user can press the manual dump actuator 114 to move the valve body 207 to the open position without rotating the pump cam shaft 106. A user can manually actuate the manual dump actuator 114 coupled to the valve body 207 to rotate the valve body 207 from the closed position to the open position while the pump cam shaft 106 is stationary. This is advantageous because the pump cam shaft 106 can be coupled to a gearbox that would resist rotation (e.g., provide a mechanical disadvantage to the user input) when the user presses the manual dump actuator 114. Once the valve body 207 is in the open position and the user stops applying a force to the manual dump actuator 114, the spring 116 generates a force to bias the valve body 207 towards the closed position. However, the one-way clutch 110, in response to the force generated by the spring 116, rotationally couples the valve body 207 to the pump cam shaft 106. In effect, the pump cam shaft 106 holds the valve body 207 in the open position as long as the drive motor 104 is stationary. In other words, the one-way clutch 110 is configured to hold the valve body 207 in a position (e.g., the open position, the first position) when the drive member 402 is stationary and the manual dump actuator 114 is released. After the valve body 207 is in the open position, the drive motor 104 can rotate the pump cam shaft 106 in the second direction which rotationally decouples the pump cam shaft 106 from the valve body 207. Once the pump cam shaft 106 is rotationally decoupled from the valve body 207, the biasing force of the spring 116 causes the valve body 207 to rotate from the open position to the closed position.

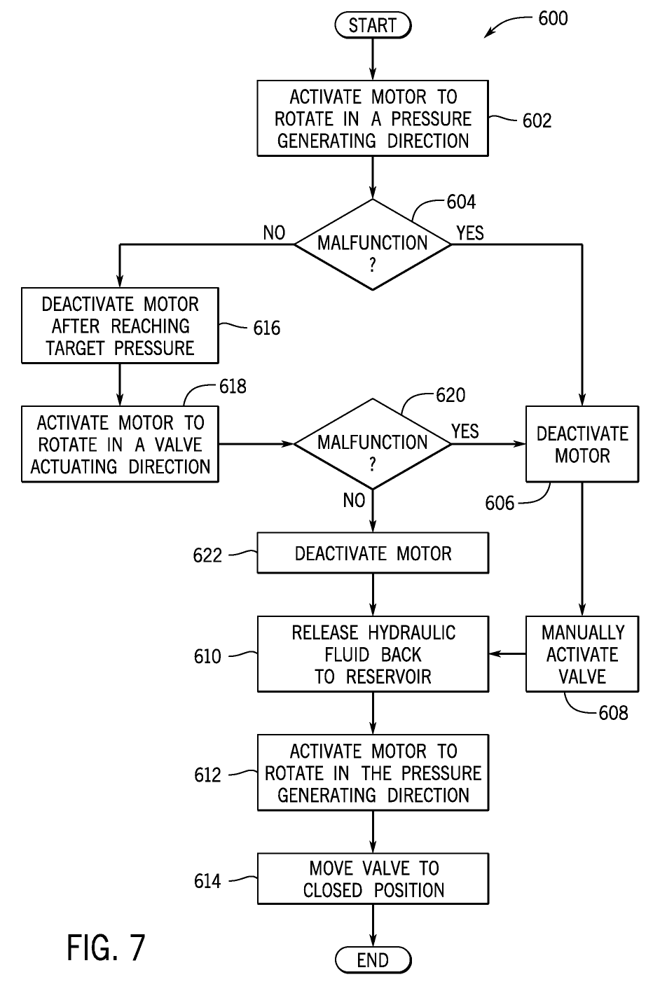

FIG. 7 is a flowchart representative of a method 600 of activating a shear valve (e.g., the shear valve 108) in a hydraulic tool (e.g., the hydraulic tool 100). While the method 600 is described with reference to a hydraulic crimper, the method 600 can also be used in other systems.

At block 602, a user activates a drive motor (e.g., the drive motor 104) of the hydraulic tool to rotate in a pressure generating direction (e.g., a second direction). The drive motor is coupled to a hydraulic pump (e.g., the pump 128) that generates hydraulic pressure to actuate a crimping head (e.g., the work head 102) of the hydraulic tool. Rotating an input shaft of the hydraulic pump (e.g., the pump cam shaft 106) in a first direction generates pressure in a hydraulic fluid. At block 604, a user determines if a malfunction has occurred. The malfunction could be, for example, a malfunction of a hydraulic piston, a malfunction of the crimping head of the hydraulic power tool, an unexpected movement of a workpiece, unexpected damage of the workpiece, misalignment of the crimping head and the workpiece, or any other malfunction relating to the use of the hydraulic tool. In some examples, the hydraulic tool, via a controller (e.g., the controller 118), detects the malfunction based on power and/or sensor readings within the hydraulic tool.

At block 606, if a malfunction is detected, the drive motor is deactivated by the user (e.g., by releasing a trigger or pressing a stop button). In some examples, the controller sends a command to stop the drive motor.

At block 608, a user manually activates or otherwise actuates the shear valve. The shear valve is a shear valve that rotates between a closed position and an open position. The shear valve can include a button or similar mechanical actuation mechanism that is functionally coupled to the shear valve and extends to or near an exterior surface of the hydraulic tool so as to be physically moved by a user’s input. A one-way clutch (e.g., the one-way clutch 110) couples the drive motor to the shear valve, allowing the shear valve to freely rotate towards the open position when the shear valve is manually activated and preventing the shear valve from rotating towards the closed position.

At block 610, hydraulic fluid that actuates the work head is released back to a hydraulic fluid reservoir (e.g., the hydraulic fluid reservoir 126) of the hydraulic tool. The hydraulic fluid is released through a fluid channel (e.g., the first fluid channel 400) of the valve body 207 when the valve body 207 is in the open position.

At block 612 the user activates the drive motor to rotate in the pressure generating direction. In some examples, the controller activates the drive motor to rotate in the pressure generating direction without user input.

At block 614, the shear valve is moved to the closed position. The rotation of the drive motor allows the shear valve to rotate towards the closed position. Once the shear valve is rotated to the closed position, the hydraulic tool is ready for a new use cycle and the method 600 ends.

Returning to block 604, if the user does not detect a malfunction while rotating the drive motor in the pressure generating direction, the method 600 can continue to block 616. At block 616, a user deactivates the drive motor after reaching a target pressure. In some examples, the controller determines, via a pressure sensor, that a target pressure has been reached and deactivates the drive motor automatically. The method 600 continues to step 618, at which the user activates the drive motor to rotate in a valve actuating direction (e.g., a second direction). The valve actuating direction is opposite the pressure generating direction (e.g., a clockwise direction versus a counterclockwise direction). Rotating the pump the input shaft in valve actuating direction causes the valve body 207 to rotate from the closed position to the open position. In response to the drive motor rotating in the valve actuating direction, the one-way clutch rotationally couples the drive motor to the shear valve and rotates the shear valve to the open position. The input shaft is coupled to the valve body via the one-way clutch 110. The one-way clutch 110 is configured to rotationally couple the input shaft to the valve body when the input shaft rotates in the valve actuating direction and rotationally decouple the input shaft from the valve body when the input shaft rotates in the pressure generating direction. In some examples, the controller of the hydraulic tool automatically instructs the drive motor to rotate in the valve actuating direction in response to detecting that the target pressure has been reached.

At block 620, the user determines if a malfunction has occurred after the drive motor was activated to rotate in the valve actuating direction. In some examples, the controller of the hydraulic tool determines if a malfunction occurred by monitoring pressure and/or motor load. If a malfunction is detected, the drive motor is deactivated at block 606. In some examples, the drive motor is deactivated by the controller after a malfunction was detected. At block 608, a user manually activates or otherwise actuates the shear valve. At block 610, hydraulic fluid that actuates the crimping head is released back to the fluid reservoir of the hydraulic tool. At block 612, the user activates the drive motor to rotate in the pressure generating direction. At block 614, the shear valve is moved to the closed position in response to the drive motor rotating in the pressure generating direction.

Returning to step 620, if a malfunction is not detected, a user deactivates the drive motor at block 622. In some examples, the controller deactivates the drive motor. The controller can determine that the drive motor is to be deactivated based on how far the shear valve has rotated, how long the drive motor has been operating, a detected increase in torque based on the shear valve contacting a rotational stop, or any other common control method. At block 610, hydraulic fluid that actuates the crimping head is released back to the hydraulic fluid reservoir of the hydraulic tool. At block 612, the user activates the drive motor to rotate in the pressure generating direction. In some examples, the controller activates the drive motor to rotate in the pressure generating direction based on determining that hydraulic fluid has returned to the hydraulic fluid reservoir. At block 614, the shear valve is moved to the closed position in response to the drive motor rotating in the pressure generating direction.

In general, examples of the shear valve and methods described herein allow for a single actuator to be used to generate hydraulic pressure or release hydraulic fluid based on a direction of rotation of the actuator. Additionally, examples of the disclosed invention can provide a system and method for relieving hydraulic pressure through a manual shear valve and one-way clutch. Thus, the apparatus and methods described herein are directed toward an improvement in the function of hydraulic tools and a reduction in total components used in said hydraulic tools.

The foregoing discussion is presented to enable a person skilled in the art to make and use examples of the invention. Various modifications to the illustrated examples will be readily apparent to those skilled in the art, and the generic principles herein can be applied to other examples and applications without departing from examples of the invention. Thus, examples of the invention are not intended to be limited to examples shown, but are to be accorded the widest scope consistent with the principles and features disclosed herein. The foregoing detailed description is to be read with reference to the figures, in which like elements in different figures have like reference numerals. The figures, which are not necessarily to scale, depict selected examples and are not intended to limit the scope of examples of the invention. Skilled artisans will recognize the examples provided herein have many useful alternatives and fall within the scope of examples of the invention.

It is to be understood that the invention is not limited in its application to the details of construction and the arrangement of components set forth in the foregoing description or illustrated in the attached drawings. The invention is capable of other examples and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items. Throughout the disclosure, the terms “about” and “approximately” refer to a range of values ± 5% of the numeric value that the term precedes. Also as used herein, unless otherwise limited or defined, “substantially parallel” indicates a direction that is within ± 12 degrees of a reference direction (e.g., within ± 6 degrees or ± 3 degrees), inclusive. Similarly, unless otherwise limited or defined, “substantially perpendicular” similarly indicates a direction that is within ± 12 degrees of perpendicular a reference direction (e.g., within ± 6 degrees or ± 3 degrees), inclusive.

The terms first, second, third, etc., may be used herein to describe various elements, components, directions, regions, layers, and/or sections. These elements, components, directions, regions, layers, and/or sections should not be limited by these terms. These terms may be only used to distinguish one element, component, direction, region, layer, or section from another direction, region, layer, or section. Terms such as “first,” “second,” and other numerical terms do not imply a sequence or order unless clearly indicated by the context. Thus, a first element, component, direction, region, layer, or section discussed below could be termed a second element, component, direction, region, layer, or section without departing from the teachings of the example configurations.

Examples of the disclosed invention can provide a system and method for relieving hydraulic pressure through a manual shear valve and one-way clutch. The previous description of the disclosed examples is provided to enable any person skilled in the art to make or use the invention. Various modifications to these examples will be readily apparent to those skilled in the art, and the generic principles defined herein may be applied to other examples without departing from the spirit or scope of the invention. Thus, the invention is not intended to be limited to the examples shown herein but is to be accorded the widest scope consistent with the principles and novel features disclosed herein.

We claim:

1. A hydraulic tool, comprising:
a valve body including a sealing surface and a side surface, the valve body to rotate between a first position and a second position;
a first fluid channel to fluidly couple the sealing surface and the side surface;
a shear seal to contact the sealing surface, the shear seal including a second fluid channel to selectively fluidly couple to the first fluid channel when the valve body is in the first position and selectively fluidly seal against the sealing surface when the valve body is in the second position;
an input shaft; and
a one-way bearing coupled between the valve body and the input shaft to control rotation of the valve body so that the one-way bearing rotationally couples the input shaft to the valve body when the input shaft rotates in a first direction and rotationally decouples the input shaft from the valve body when the input shaft rotates in a second direction that is opposite.

2. The hydraulic tool of claim 1 further comprising a manual input coupled to the valve body so that actuation of the manual input rotates the valve body from the second position to the first position.

3. The hydraulic tool of claim 2 further comprising a biasing element configured to bias the valve body toward the second position.

4. The hydraulic tool of claim 1, wherein the first direction corresponds to the valve body rotating from the second position to the first position.

5. The hydraulic tool of claim 4, wherein the valve body includes a protrusion configured to contact a surface of the hydraulic tool when the valve body is in the first position, the surface configured to prevent rotation of the valve body in the first direction when the protrusion contacts the surface.

6. The hydraulic tool of claim 1, wherein the input shaft is a pump shaft of the hydraulic tool.

7. The hydraulic tool of claim 6 further comprising a motor coupled to the input shaft.

8. The hydraulic tool of claim 7, wherein the hydraulic tool is configured to generate hydraulic pressure when the motor rotates the input shaft in the second direction.

9. The hydraulic tool of claim 1, wherein the one-way bearing is configured to hold the valve body in the first position when the input shaft is stationary.

10. The hydraulic tool of claim 1, further comprising a thrust bearing disposed between the valve body and a pump housing.

11. The hydraulic tool of claim 1, wherein the sealing surface is substantially perpendicular to an axis of rotation of the valve body.

12. A shear seal valve comprising:
a one-way clutch including a drive member and a driven member;
a valve body defining a first fluid passage, the valve body coupled to rotate with the driven member so that the valve body rotates with the drive member when the drive member is rotated in a first direction and is rotatable relative to the drive member when the drive member is rotated in a second direction that is opposite the first direction; and
a manual input coupled to the valve body so that actuation of the manual input causes the valve body to rotate relative to the drive member.

13. The shear seal valve of claim 12, further comprising a shear seal that couples to the first fluid passage when the valve body is in a first position and that seals against the valve body when the valve body is in a second position.

14. The shear seal valve of claim 13, wherein the shear seal is biased toward the valve body by a resilient member.

15. The shear seal valve of claim 13, wherein rotation of the drive member in the first direction or actuation of the manual input causes the valve body to move from the second position to the first position.

16. The shear seal valve of claim 12, wherein the one-way clutch is configured to hold the valve body in a position when the drive member is stationary and the manual input is released.

17. The shear seal valve of claim 12, further comprising a spring to bias the manual input toward an unactuated position and to bias the valve body toward a sealed position.

18. The shear seal valve of claim 12, wherein the drive member is coupled to a cam of a hydraulic pump.

19. A method of operating a hydraulic tool, comprising:
rotating an input shaft in a first direction to generate pressure in a hydraulic fluid;
rotating the input shaft in a second direction that is opposite the first direction;
rotating a valve body from a closed position to an open position, based on rotation of the input shaft in the second direction; and
releasing the hydraulic fluid through a fluid channel of the valve body when the valve body is in the open position,
wherein the input shaft is coupled to the valve body via a one-way clutch, and
wherein the one-way clutch is configured to rotationally couple the input shaft to the valve body when the input shaft rotates in the second direction and to rotationally decouple the input shaft from the valve body when the input shaft rotates in the first direction.

20. The method of claim 19, further comprising manually actuating a manual input coupled to the valve body to rotate the valve body from the closed position to the open position while the input shaft is stationary.
